(19) United States
(12) Patent Application Publication
(10) Pub. No.: US 2012/0005381 A1
(43) Pub. Date: Jan. 5, 2012

(54) UNIVERSAL SERIAL BUS (USB) INTERFACE DEVICE HAVING FUNCTIONS OF HIGH DEFINITION CONVERSION AND AUDIO SUPPORTING

(76) Inventor: MING-HAN HSIEH, Zhonghe City (TW)

(21) Appl. No.: 12/826,683

(22) Filed: Jun. 30, 2010

(51) Int. Cl. G06F 13/12

(52) U.S. Cl. 710/69

(57) ABSTRACT

Provided is a USB interface device includes a USB unit, a USB to digital video and digital audio module, a high-definition multimedia interface (HDMI) module, a memory control unit (MCU), and a power control module. The USB to digital video and digital audio module receives and converts video and audio signals into digital signals, which are then converted by the module to be applied to a displaying device (such as a displaying screen or a TV set). The USB to digital video and digital audio module contains a built-in EDID module to provide the optimum resolution data to the displaying device. As such, WUXGA (Widescreen Ultra. Extended Graphics Array) resolution can be realized and audio effect is supported.

### (a) TECHNICAL FIELD OF THE INVENTION

The present invention generally relates to a USB (Universal Serial Bus) interface device having functions of high definition conversion and audio supporting, which is simple, practical, and convenient to use, effectively increases displaying resolution of screen, and supports HDCP (High-bandwidth Digital Content Protection).

### (b) DESCRIPTION OF THE PRIOR ART

A displaying device plays an important role as a bridge between people and data transmission and must perform the operation in the best way to satisfy the most criticizing eyes of general consumers. Thus, all kinds of consumer products, including portable devices, information devices, or video devices, are involved with increasingly demanded displaying result and are also developed to meet the needs of applications and environments of use of end-user products.

The currently available video interfaces include VGA (Video Graphics Array), DVI (Digital Visual Interface), and HDMI (High-Definition Multimedia Interface), or alternatively, a USB is used to directly couple to DVI. All these techniques provide a maximum resolution of 4:3 and thus a standard of 1600×1200 maximum resolution for UXGA (Ultra eXtended Graphics Array). And, this does not include audio components, so that a user must arrange for an additional output for audio signals. This is certainly troublesome.

The current trend in the recent years is widescreen displaying, which is commonly accepted by the general consumers. To satisfy the needs of the modern society, new versions of technology in this field are emerging. The 4:3 resolution displaying is fading away and getting out of market. Consequently, the UXGA displaying devices no longer satisfy the needs of the market. The substitute, newly-developed WUXGA (Widescreen Ultra eXtended Graphics Array) that is a new version of UXGA supporting HDMI resolution and showing a maximum definition of 1920×1200 and an aspect ratio of 16:10 and includes audio signals is becoming a new trend of the current market.

Thus, the present invention aims to provide a USB interface device that follows the current trend to provide improvement of screen displaying resolution, supporting to HDCP and extended displaying mode.

### SUMMARY OF THE INVENTION

An objective of the present invention is to provide a USB (Universal Serial Bus) interface device having functions of high definition conversion and audio supporting in order to effectively increase screen resolution and to support HDCP (High-bandwidth Digital Content Protection) and extended displaying mode. In architecture, the USB interface device comprises a USB unit, a USB to digital video and digital audio module, a high-definition multimedia interface (HDMI) module, a memory control unit (MCU), and a power control module. The USB unit is connected to a computer system to receive video and audio signals from the computer system. The USB to digital video and digital audio module is connected to the USB unit to receive and convert the video and audio signals into digital signals and comprises an EDID (Extended Display Identification Data) module. The HDMI module is connected to the USB to digital video and digital audio module and a display. The MCU is connected to the USB to digital video and digital audio module and the HDMI module and functions for storage of data and detection of signal frequency and controls of the USB to digital video and digital audio module and the HDMI module, and also functions to carry out operations of reading and writing of the EDID module. The power control module supplies electrical power. When the computer system supplies an output of color images and audio signals through the USB unit, the images and audio signals are converted by the USB to digital video and digital audio module into corresponding digital signals, which are then converted by the HDMI module into a video image to be displayed on the display, and meanwhile, the EDID module of the USB to digital video and digital audio module communicates the computer system to identify and transmit resolution of video output to the MCU, which makes the USB to digital video and digital audio module and the HDMI module carrying out necessary corrections, so as to obtain a displaying image or an extended displaying mode with a resolution corresponding to Widescreen Ultra Extended Graphics Array (WUXGA) and supporting audio effect.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram showing an embodiment of the present invention.

FIG. 2 is a flow chart showing a method of increasing displaying resolution and extended displaying mode according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

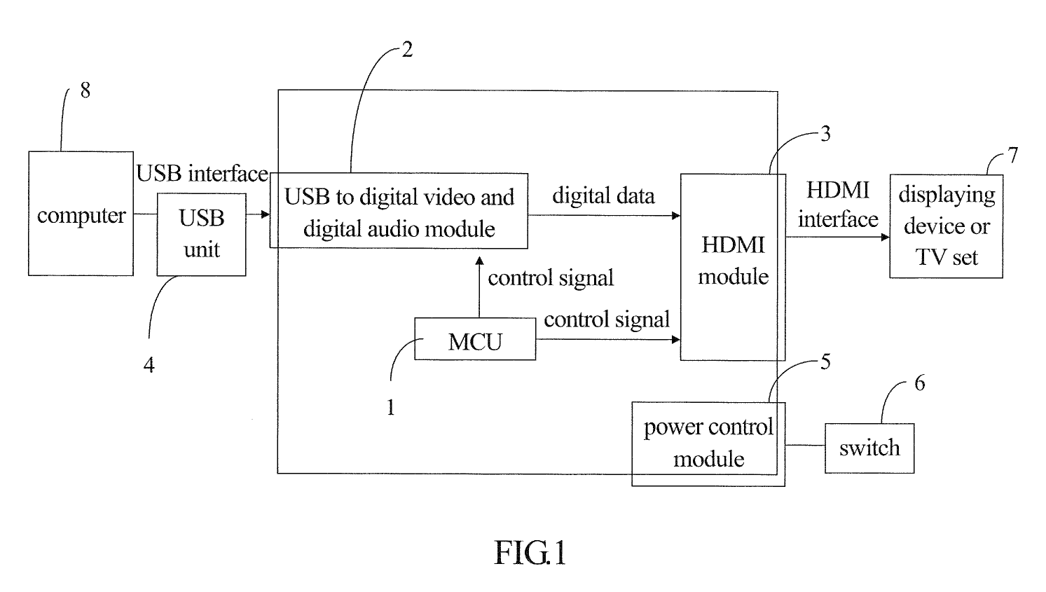

Referring to FIG. 1, a USB (Universal Serial Bus) interface device having functions of high definition conversion and audio supporting according to a preferred embodiment of the present invention comprises a memory control unit (MCU) 1, a USB to digital video and digital audio module 2, which will be referred to in an abbreviated formed as USB-to-V/A module, an HDMI (High-Definition Multimedia Interface) module 3, a USB unit 4, and a power control module 5.

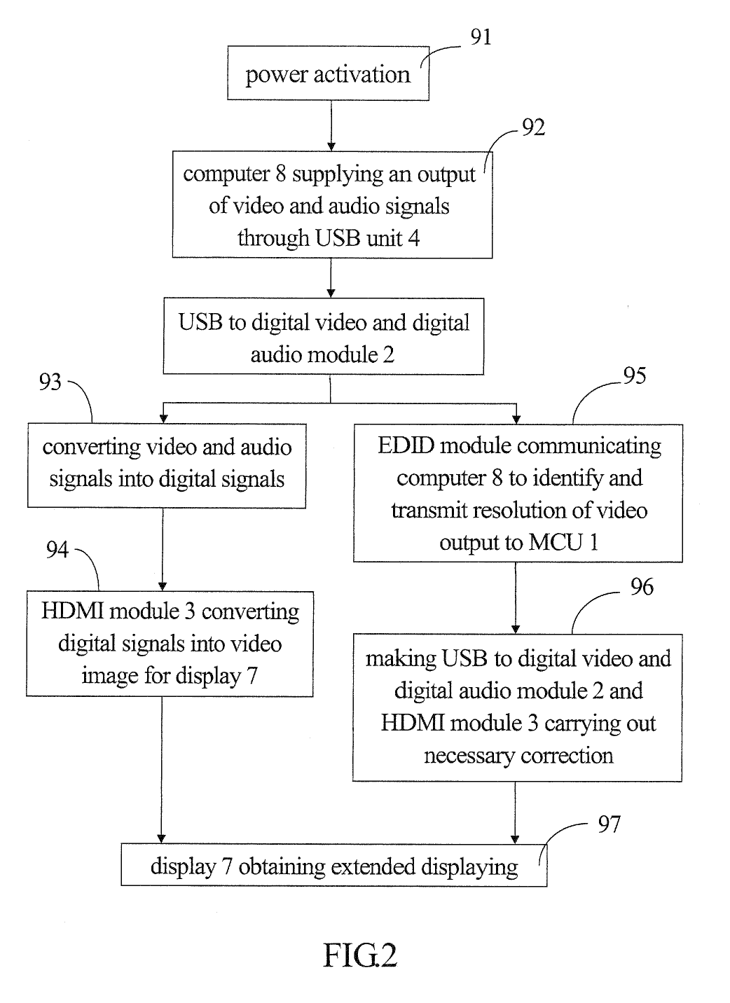

Referring to FIGS. 1 and 2, the MCU 1 provides operations of data storage and signal frequency detection, and also controls the USB-to-V/A module 2 and the HDMI module 3.

The USB-to-V/A module 2 converts video and audio signals received from the USB unit 4 into corresponding digital signals and supplies the converted signals to the HDMI module 3. The USB-to-V/A module 2 is coupled to a computer system 8 through the USB unit, and is also coupled to the MCU 1. The USB-to-V/A module 2 comprises an EDID (Extended Display Identification Data) module, which supplies correct identification data of optimum resolution to the computer system 8 for proper operation.

The HDMI module 3 is connected to the USB-to-V/A module 2 and a display 7 (such as a displaying screen of a personal computer or a television set), and also forms communication relationship with the MCU 1. The HDMI module 3 provides standards of video interface that allows for digitalized transmission for enhancing displaying quality of the display 7.

The USB unit 4, which serves as a USB interface, works as a serial bus standard for connection between a personal computer 8 and an external device and also provides technical specifications for input and output interfacing. The USB has been widely used in various information and communication appliances, including personal computers and mobile devices, and also shows extended applications in other related fields, such as photographing devices, digital television sets (such a set-top box), and game machines. According to the present invention, video and audio signals from the computer system 8 are transmitted through the USB unit 4 to the USB-to-V/A module 2.

The power control module 5 controls regulation of electrical voltage and provides electrical voltages and currents to meet the need of each of these. The power control module 5 comprises an ON/OFF switch 6.

According to the present invention, a method for enhancing displaying resolution and extended displaying function of a display comprises the following steps:

Step 91, in which power is set on; the power control module 5 supplies a required current to each unit;

Step 92, in which a computer system 8 supplies video and audio signals through the USB unit 4 to the USB-to-V/A module 2;

Step 93, in which the USB-to-V/A module 2 receives and converts the video and audio signals transmitted through the USB unit 4 into corresponding digital signals and further applies the converted digital signals to the HDMI module 3;

Step 94, in which the HDMI module 3 converts the digital signals into a video image to be displayed on a display 7; the HDMI module 3 contains built-in HDCP (High-Bandwidth Digital Content Protection), which protects digitalized video and audio data from unauthorized duplication during transmission through DVI (Digital Visual Interface) or HDMI and also maintains desired image quality;

Step 95, in which the EDID module contained in the USB-to-V/A module 2 makes communication with the computer system 8, at the time when the USB-to-V/A module 2 executes Step 93, so as to identify and transmit the resolution of video output to the MCU 1;

Step 96, in which the MCU unit 1 makes the USB-to-V/A module 2 and the HDMI module 3 carrying out necessary correction of the image; and

Step 97, in which, after Step 96, an extended displaying mode can be realized for a case where the HDMI module 3 is connected to two displaying devices, whereby a desired displaying effect of WUXGA (Widescreen Ultra eXtended Graphics Array) having maximum resolution of 1920×1200 and aspect ratio of 16:10 of the so-called UXGA (Ultra eXtended Graphics Array) format can be realized.

In summary, the present invention provides a USB interface device having functions high resolution conversion and audio supporting, and the USB interface device supports WUXGA displaying and audio function and also provides an extended displaying mode so as to effectively overcome the “bottle neck” of the conventional screen resolution and allows for multimedia operation.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A universal serial bus (USB) interface device, comprising:
a USB unit, which is adapted to connect to a computer system to receive video and audio signals from the computer system;
a USB to digital video and digital audio module, which is connected to the USB unit to receive and convert the video and audio signals into a digital image and which comprises an EDID (Extended Display Identification Data) module;
a high-definition multimedia interface (HDMI) module, which is connected to the USB to digital video and digital audio module and is also adapted to connect to a display;
a memory control unit (MCU), which is connected to the USB to digital video and digital audio module and the HDMI module and which functions for storage of data and detection of signal frequency and controls of the USB to digital video and digital audio module and the HDMI module, and also functions to carry out operations of reading and writing of the EDID module; and
a power control module, which supplies electrical power;
wherein when the computer system supplies an output of color images and audio signals through the USB unit, the images and audio signals are converted by the USB to digital video and digital audio module into corresponding digital signals, which are then converted by the HDMI module into a video image to be displayed on the display, and meanwhile, the EDID module of the USB to digital video and digital audio module communicates the computer system to identify and transmit resolution of video output to the MCU, which makes the USB to digital video and digital audio module and the HDMI module carrying out necessary corrections, so as to obtain a displaying image or an extended displaying mode with a resolution corresponding to Widescreen Ultra Extended Graphics Array (WUXGA) and supporting audio effect.

2. The USB interface device according to claim 1, wherein the HDMI module comprises high-bandwidth digital content protection built therein.
